(19) United States
(12) Patent Application Publication
(10) Pub. No.: US 2025/0022450 A1
(43) Pub. Date: Jan. 16, 2025

(54) ACOUSTICALLY ACTIVE COMPONENT, ACOUSTICALLY ACTIVE MOLDED PARTS, METHOD FOR PRODUCING AN ACOUSTICALLY ACTIVE COMPONENT AND ACOUSTICALLY ACTIVE MOLDED PARTS, AND ADVANTAGEOUS APPLICATIONS OF AN ACOUSTICALLY ACTIVE COMPONENT OR ACOUSTICALLY ACTIVE MOLDED PARTS

(71) Applicant: CARCOUSTICS TECHCONSULT GMBH, Leverkusen (DE)

(72) Inventors: Martin PACKHÄUSER, Burscheid (DE); Detlef WINKLER, Wolfsburg (DE); Miguel SEBASTIA, Catarroja-Valencia (ES); Paul SCHÖNZART, Leverkusen (DE)

(21) Appl. No.: 18/578,216

(22) PCT Filed: Jun. 30, 2022
(86) PCT No.: PCT/EP2022/068195

§ 371 Date: Mar. 19, 2024

(30) Foreign Application Priority Data
Jul. 13, 2021 (DE) 10 2021 118 113.5
Dec. 7, 2021 (DE) 10 2021 132 224.3
Mar. 21, 2022 (DE) 10 2022 106 505.7

(51) Int. Cl. G10K 11/168; B60R 13/08

(52) U.S. Cl. CPC G10K 11/168; B60R 13/0815

(57) ABSTRACT

An acoustically active component, to acoustically active molded parts, to a method for producing an acoustically active component and acoustically active molded parts, and to advantageous applications of an acoustically active component or acoustically active molded parts. The components or molded parts are particularly suitable for use as acoustically active interior or exterior components for a motor vehicle.

### CROSS-REFERENCE TO RELATED APPLICATIONS

This application is a 35 U.S.C. § 371 National Stage patent application of PCT/EP2022/068195, filed on 30 Jun. 2022, which claims the benefit of German patent application 10 2021 118 113.5, filed on 13 Jul. 2021, German patent application 10 2021 132 224.3, filed on 7 Dec. 2021, and German patent application 10 2022 106 505.7, filed on 21 Mar. 2022, the disclosures of which are incorporated herein by reference in their entirety.

### TECHNICAL FIELD

The subject matter of the present disclosure includes an acoustically-effective component, acoustically-effective moulded parts, methods for the production of an acoustically-effective component, together with acoustically-effective moulded parts, together with advantageous of an acoustically-effective component or acoustically-effective moulded parts.

### BACKGROUND

A variety of acoustically-effective components are known from the prior art. Thus, DE 35 06 004 A1 discloses an acoustically-effective filler body, which consists of an open-cell 3D-moulded foam body that is wrapped in a plastic film impermeable to air. In DE 35 06 004 A1, it is proposed to prefabricate appropriate filler bodies in the compressed state during manufacture, so that in the delivered state these filler bodies can be inserted directly into cavities that are to be sealed. Subsequently, the plastic envelope of the filler body is to be perforated, which results in an expansion of the filler body such that the filler body seals the cavity and is held fixed in the latter. However, a disadvantage of the filler body of known art from DE 35 06 004 A1 is that the production of a three-dimensionally moulded foam block using the methods known from the prior art is time-consuming and therefore cost-intensive.

If more complex shaped filler bodies are to be produced, appropriately three-dimensionally shaped foam bodies must be produced; this is preferably achieved using moulded foams in accordance with the prior art. For this purpose, a reactive mixture of two components is injected into a heated mould, in which the components react with each other to form a foam block that may also, if applicable, have a complex shape. However, the reaction times of the components must here be taken into account, so that the moulding of such a foam block in practice requires mould closure times of 120 seconds or more. This results in long cycle times, which makes production more expensive. The closed envelope of the filler body is also acoustically disadvantageous; this has a sound-reflecting effect, so that the ability of the filler body to absorb sound is significantly reduced.

DE 10 2013 101 151 A1 also discloses an acoustically-effective filler body for insertion into a cavity, e.g. of a vehicle body. The filler body comprises a plastic envelope, together with a foam filling material inserted into the plastic envelope. The foam filling material comprises foam flakes, which are introduced into the plastic envelope as infill or randomly arranged flakes. In the case of this filler body the closed envelope of the filler body has also proved to be acoustically disadvantageous, as it has a sound-reflecting effect, so that the ability of the filler body to absorb sound is significantly reduced.

The filler body of known art from EP 0 680 845 A1 is also based on the use of foam flakes. The filler bodies disclosed there have an envelope made from a gas-impermeable film that is filled with open-cell or mixed-cell foam flakes, evacuated, and then sealed. The evacuated filler bodies are then inserted into cavities that are to be acoustically sealed, where the envelope is punctured so that the compressed foam flakes can re-expand, resulting in a mechanical hold of the filler bodies by means of a tight fit. However, in practice it has been shown that the acoustic performance of these filler bodies is limited beyond a pure sealing action, om account of the acoustically hard envelope.

### SUMMARY

Against this background, the present disclosure provides an acoustically-effective component, that is to say, an acoustically-effective moulded part, which has improved acoustic properties. Furthermore, the present disclosure specifies advantageous methods for the production of an acoustically-effective component, together with acoustically-effective moulded parts. Finally, the present disclosure specifies advantageous uses of an acoustically-effective component, that is to say, acoustically-effective moulded parts.

This is achieved by providing a component, by a moulded part, by various methods, and by a use in accordance with the claims.

It should be noted that the features listed individually in the claims can be combined with each other in any technically logical manner (even across category boundaries, for example between method and device), and can demonstrate further configurations of the disclosure. The description characterises and specifies the disclosure, in particular in conjunction with the figures.

It should also be noted that a conjunction “and/or”, used herein between two features and linking them together, is always to be interpreted such that in a first configuration of the inventive subject-matter only the first feature may be present, in a second configuration only the second feature may be present, and in a third configuration both the first and the second feature may be present.

An acoustically-effective component in accordance with the disclosure has a pouch formed from at least a first cover layer, which forms at least a first chamber. Here the first cover layer comprises a flexible material with an extended surface area, which has a specific flow resistance of between 10 and 1,500 rayls (in the MKS system), or consists of such a material. The sound characteristic impedance, also known as acoustic field impedance or specific acoustic impedance, is measured more precisely in the rayl unit. All values in rayls relating to the present disclosure refer to the MKS system.

This first chamber is filled with a first filling, wherein the first filling comprises:
i) voluminous non-woven material,
ii) foam particles,
iii) synthetic fibres,
iv) natural fibres; or
v) mixtures of the aforementioned materials.

If a voluminous non-woven material is used, the use of a non-woven material made from thermoplastic fibres, in particular polypropylene (PP), polyethylene terephthalate (PET) or polyether sulfone (PES) fibres, or mixtures of the aforementioned fibres, has proved to be particularly advantageous. Both flakes of voluminous non-woven materials and segments of voluminous non-woven materials with an extended surface area, can be used in the context of the disclosure.

Material remnants of planar voluminous non-woven materials, e.g. offcuts, such as those produced in the production of non-woven material-based stamped parts, which are frequently used in the automotive sector, can also advantageously be used in the context of the present disclosure.

In the context of the present disclosure, the term “voluminous non-woven material” should also be understood to mean one-piece segments of voluminous non-woven materials, whose shape is adapted to the chamber formed in the pouch.

In particular, shredded remnants of an open-cell or mixed-cell foam made from PUR (polyurethane) or preferably from viscoelastic PUR, or mixtures thereof, can be used as foam particles. These foams are available in large quantities as material remnants. They are produced in the manufacture of mattresses, for example. The production of foam-based stamped parts, which are often used in the automotive sector, also produces large quantities of material remnants that can advantageously be used in the context of the present disclosure. However, the use of shredded remnants of suitable foams from recycling is also advantageously possible.

In the context of the present disclosure, the term “foam particles” should also be understood to mean one-piece foam blocks, whose shape is adapted to the chamber formed in the pouch.

In the case of synthetic fibres, the use of fibres made from a thermoplastic material such as PP, PET or PES, or at least containing a proportion of these, has proved particularly successful. In particular, such fibres can come from a recycling process.

The use of so-called bicofibres (=two-component fibres) has proved to be particularly advantageous. These fibres consist of two components that have different melting/softening points. Bicofibres with a core made from a high-melting polymer material, in an envelope made from a low-melting polymer material such as PET, have proved to be particularly advantageous. In principle, thermosetting polymer materials can also be used for the core. In a thermoforming process, the material of the envelope acts as a binder, while the core material ensures high mechanical strength, even at higher temperatures.

Cotton fibres, fibres made from kapok, rice, hemp or flax have proved to be suitable as natural fibres. In an advantageous development, a thermosetting binder, for example a phenolic resin, is also added to the list of natural fibres.

It should be noted that the density of the filling can be influenced on the one hand by the selection of the material for the filling, but also, on the other hand, by the quantity of filling introduced into the first chamber, i.e. by the compaction of the material introduced into the chamber.

The first cover layer, provided in accordance with the disclosure, has an acoustic permeability that can be adapted to the specific intended use of the acoustically-effective component by a focussed selection of materials.

A specific flow resistance of between 80 and 120 rayls has proved to be particularly effective acoustically in the central to higher frequency range of the human hearing spectrum.

If a particularly high effectiveness is to be achieved at low frequencies of the human hearing spectrum, a specific flow resistance of 750 rayls±50 rayls has proved to be particularly effective.

The filling, provided in accordance with the disclosure, has a high acoustic absorption capability, which by means of a focussed selection of materials and/or combination of materials can be adapted to the specific intended use of the acoustically-effective component.

The selection of a suitable material for the first cover layer, together with the filling adapted to the specific intended use of the acoustically-effective component, lies within the scope of the normal expertise of a person skilled in the art, to which reference is made at this point.

The materials specified for the filling can be produced specifically for use in the context of the present disclosure. Advantageously, however, use is made of materials that are produced as material remnants in other manufacturing processes. In this manner, these material remnants can be put to a practical use and do not have to be disposed of in a cost-intensive and ecologically disadvantageous manner. On the one hand, this makes it possible to achieve cost advantages in the procurement of the raw materials required to carry out the present disclosure. On the other hand, high recycling rates can be achieved with the inventive components and moulded parts without having to accept disadvantages in quality.

It has proved to be particularly advantageous if the material of the first cover layer comprises a non-woven material, or consists of a non-woven material. A large number of non-woven materials with a very wide range of specific flow resistances are available on the market, ensuring that a material suitable for a specific intended use is available for the first cover layer.

The same applies if the first cover layer is designed as a micro-perforated film.

The characteristic dimensions of the individual micro-perforations in a micro-perforated film are particularly preferably selected in such a way that the micro-perforated film has a high permeability for water vapour, but at the same time a low permeability for liquid water. In this context, it has proved to be advantageous if the characteristic dimensions of the micro-perforations are smaller than 100 microns, and preferably not larger than 60 microns. A characteristic dimension is understood to be a length that characterises the typical size of the individual micro-perforations. For example, in the case of essentially round micro-perforations, the diameter is to be taken as the characteristic dimension.

Regardless of the specific design of the first cover layer, it has proved to be advantageous if the material of the first cover layer can be thermally welded. This is the case, for example, if at least one thermoplastic material is also used as a material for the first cover layer. PP, PET or PES have proved to be particularly suitable here.

If a film material is used for the first cover layer, the use of a duplex film, which has at least one layer made from a thermoplastic material such as PP, PET or PES, has proved to be advantageous in addition to the use of a single-layer film.

The film is preferably designed to be flame-retardant, using suitable additives that are known from the prior art.

In overall terms, there are advantages with regard to processing the film if the film that is used can be welded. Both thermal weldability, and also weldability by means of ultrasound or friction welding can be advantageous. In principle, however, other welding methods known from the prior art can also be used to advantage.

The use of a film comprising, or consisting of. PE, with a thickness of no less than 30 microns and no more than 60 microns, preferably about 40 microns, has proved to be particularly suitable in terms of tear resistance on the one hand, and an efficient use of material on the other. Higher material thicknesses up to more than 100 microns are possible and allow an increase in tear resistance.

It has proved to be particularly advantageous if the density of the film is between 0.8 and 1.2 g/cm³. A film with a density of about 1.0 g/m³ is preferably used.

In an advantageous configuration of the disclosure, a thermoplastic fibre material, for example one made from PET fibres, is used for a first cover layer made from a non-woven material.

The use of needled non-woven materials has proved to be particularly effective, especially when a non-woven material based on PET fibres is used.

A very good balance between acoustic performance and tear resistance is achieved if the thickness of the non-woven material is between 0.7 and 1.5 millimetres, especially if a needled non-woven material made from PET fibres is used.

A very good balance between acoustic performance and tear resistance is also achieved if the weight per unit surface area of the non-woven material is between 30 and 50 g/m³, especially if a needled non-woven material made from PET fibres is used.

A very good acoustic performance is achieved if the air permeability of the non-woven material in accordance with DIN EN ISO 9237 is about 4000-6000 l/m²s.

In an advantageous development, an acoustically-effective component in accordance with the present disclosure has a second cover layer with an extended surface area, wherein the first and second cover layers are connected to one another in such a way that the first and second cover layers together form a pouch that comprises a chamber.

For this purpose, the first cover layer and the second cover layer can, for example, be connected to one another at the edges.

For this purpose, it is particularly advantageous if at least the material of the first cover layer, or the material of the second cover layer, can be welded, but preferably the materials of both cover layers can be welded.

In overall terms, any of the materials mentioned above as suitable or advantageous for the first cover layer can also advantageously be used for the second cover layer.

If the first and second cover layers can be welded together, the resulting inventive component can be thermoformed, i.e. a shape that is permanently stable can be impressed on such a component in a moulding tool using heat and pressure in a forming process.

If the inventive component has a first and a second cover layer, this results in a wide range of possible applications, which are described below. Here it is assumed that the first cover layer is designed as a non-woven material or micro-perforated film.

If the component in accordance with the disclosure is not intended to be used in a humid environment, it can be acoustically advantageous if the second cover layer comprises a non-woven material or a micro-perforated film, or consists of such a film. In particular, the second cover layer can have a specific flow resistance that is similar or identical to that of the first cover layer.

In certain applications, however, it can also be advantageous if the second cover layer has a non-woven material or a micro-perforated film that has a specific flow resistance that differs significantly from the specific flow resistance of the first cover layer. In particular, a specific flow resistance of less than 50 rayls can be advantageous, since such a cover layer already has a very high impermeability to liquid media.

In particular, if the component in accordance with the disclosure is intended to be used in a humid environment, it can be advantageous if the second cover layer comprises a media-impermeable film, or consists of such a film. Such components can be used in environments that require at least one side of the component to be media-impermeable. Examples include door insulations, or wheel arch insulations, for motor vehicles.

However, the use of a media-impermeable film as a material for the second cover layer can also be advantageous if the inventive acoustically-effective component is to have not only sound-absorbing properties, but also sound-insulating properties. A second cover layer made from a media-impermeable film has a high reflectivity for sound, as a result of which such an inventive component has a good sound-insulating capability.

Irrespective of the choice of materials for the first and second cover layers, the first and second cover layers are preferably sewn, pressed, bonded, or welded together. If only one cover layer is provided, this is advantageously sewn, pressed, bonded, or welded to itself to form a pouch.

Welding of the first and second cover layers is particularly favoured, as welding has production-related advantages, and allows a particularly high degree of media-impermeability.

In an advantageous development of the inventive component, the inventive chamber provided is also filled with a second filling. The second filling can also comprise, or consist of, the following materials:
i. voluminous non-woven material,
ii. foam particles,
iii. synthetic fibres,
iv. natural fibres,
v. particles of a polymeric or rubber-elastic heavy-duty layer, or
vi. mixtures of the aforementioned materials.

With regard to the properties of the aforementioned materials, reference is made to the statements made concerning the materials cited as suitable materials for the inventive (first) filling of the first chamber.

The first and second fillings can have different densities and different materials as well as different material compositions. The acoustic properties of the inventive component can be optimised for the intended use by selecting the appropriate material for the first and second fillings.

In a further advantageous development of an inventive component, the pouch forms at least two chambers. The second chamber is filled with a second filling. The second filling may also comprise, or consist of, the following materials:
i. voluminous non-woven material,
ii. foam particles,
iii. synthetic fibres,
iv. natural fibres,
v. particles of a polymeric or rubber-elastic heavy-duty layer, or
vi. mixtures of the aforementioned materials.

It should be noted that in the context of the present disclosure, the terms foam particles and foam flakes are used synonymously.

With regard to the properties of the aforementioned materials, reference is made to the statements made concerning the materials cited as suitable materials for the inventive first or second filling of the first chamber.

In a first preferred configuration of the disclosure, the first and second fillings are identical.

In a second preferred configuration of the disclosure, the first and second fillings are different. Here the first and second fillings can have different densities, different materials, and also different material compositions. By an appropriate selection of the material of the first and second filling, the acoustic properties of the inventive component can be optimally matched to the intended use.

In principle, the second filling in both of the aforementioned configurations can also comprise materials that only have low, or practically no, acoustic absorption properties in the relevant frequency range, but a relatively high density, such that a layer made from such a material has at least a good acoustic insulating effect.

In an advantageous configuration of the disclosure, it is therefore envisaged that the material for the second filling is selected such that a layer of such a material has at least a good acoustic insulating effect. In particular, a second chamber is provided on the inventive component or moulded part, which is filled with this material. The result is a component or moulded part which, in addition to sound-absorbing properties, also has sound-insulating properties.

Sections or particles made from polymeric, preferably rubber-elastic materials, for example, have proved to be suitable materials here. However, segments or particles comprising heavy-duty layers of acoustically-effective components, e.g. from the automotive industry, have also proved to be suitable in principle. These segments or particles can, for example, be in the form of a granulate, with a typical grain size of 2 to 3 millimetres.

In a further advantageous development of an inventive component with two chambers, it is envisaged that the component also has an intermediate layer that separates the first and second chambers from one another.

If a first and a second cover layer are provided, the intermediate layer is advantageously arranged between the first and second cover layers, so that the first and second cover layers and the intermediate layer together form a pouch with two chambers. Advantageously, but not necessarily, the first and second cover layers and the intermediate layer are joined together at the edges for this purpose.

In this development, the intermediate layer can be designed as a non-woven material, a micro-perforated film, or a media-impermeable film.

If the intermediate layer is designed as a non-woven material, or as a micro-perforated film, it preferably has a specific flow resistance of between 10 and 1,500 rayls. Here, too, it has proved to be particularly effective acoustically, in the medium to higher frequency range of the human hearing spectrum, if the specific flow resistance of the intermediate layer, which is designed as a non-woven material or a micro-perforated film, is between 80 and 120 rayls.

If, on the other hand, a particularly high effectiveness is to be achieved at low frequencies of the human hearing spectrum, a specific impedance of 750 rayls±50 rayls for the intermediate layer, which is designed as a non-woven material or a micro-perforated film, has proved to be particularly effective.

If, on the other hand, the film of the intermediate layer is designed to be media-impermeable, as is the second cover layer, but the first cover layer is not, and the first cover layer, the second cover layer and the intermediate layer are joined together in a media-impermeable manner, e.g. welded, bonded, or pressed, the intermediate layer forms a media-impermeable barrier between the first and second chambers. In this configuration, one chamber can be used in a humid environment, while the other chamber is arranged in a dry environment, resulting in a wide range of applications for such a component.

However, such a configuration can also be advantageous from an acoustic point of view, as the impermeable intermediate layer is an effective sound reflector that can be used, for example, to keep sound away from the passenger compartment of a motor vehicle.

In a further preferred configuration of the inventive component, the material of the intermediate layer can also be welded in the same way as the first, and, if applicable, the second cover layer, in the aforementioned preferred configurations of the inventive component. For this purpose, the intermediate layer may in particular comprise, or consist of, a thermoplastic material such as PP, PET or PES. In this configuration, the resulting inventive component has improved thermoformability.

If a first and a second filling are used for an inventive component, irrespective of whether these are arranged in a common chamber or in separate chambers, the first and the second filling can have the same densities. As a rule, however, they will have different densities in order to achieve different acoustic properties for the first absorber layer formed by the first filling, and the second absorber layer formed by the second filling. In the context of this configuration, the term “absorber layer” is to be interpreted broadly, so that a filling with a low acoustic absorption capability, but a high acoustic insulating effect, is also to be regarded as an absorber layer.

In order to achieve different acoustic properties for the first and second absorber layers in this preferred development, the first and second fillings can comprise different materials or material compositions. In this case, the first and second absorber layers advantageously have different densities, but this is not necessarily required.

Needless to say, the first and second fillings can also comprise the same materials or material compositions. In this case also, the first and second absorber layers advantageously have different densities, but this is not necessarily required.

In a further advantageous configuration of the inventive component, the first and/or, if applicable, the second filling, comprise, or consist of, foam particles. These foam particles preferably comprise an open-cell, and/or a mixed-cell, foam. In this manner, high acoustic absorption values can be achieved.

In this configuration, it has proved to be advantageous if the foam particles have an average size of at least 10 millimetres. Foam particles with this minimum size can also be easily handled in automated production methods.

In this configuration, it has also been found that particularly good acoustic absorption properties can be achieved if the first and/or, if applicable, the second filling that may also be provided, have an average density of 24 kg/m³±6 kg/m³.

It should be noted that in the context of the present disclosure, the density of a foam or foam particle is always to be understood as the mass per unit volume of the foam in its relaxed state, unless another state of compression of the foam is explicitly referred to.

Surprisingly, it has been found that the use of foam particles with an average density of significantly less than 20 kg/m³, i.e. from 10 kg/m³ to 15 kg/m³, can also lead to the production of inventive components with acoustic properties that are at least partially advantageous. For this purpose, the first filling, and/or, if applicable, the second filling, is compressed at least partially or in sections during the production of an inventive component, so that the density of the compressed foam particles is more than 20 kg/m³, preferably more than 30 kg/m³, and particularly preferably more than 40 kg/m³. Such a compression of the foam flakes can take place, for example, during the thermoforming of an inventive component.

Furthermore, it has been found that thermoformed inventive components have a particularly high-quality appearance if the typical dimensions of the foam flakes or other materials used for the filling are not larger than 10 millimetres, and preferably are smaller than 10 millimetres. This applies in particular if the filling comprises, or consists of, foam flakes. In this configuration, the structure of the first or second filling hardly appears on the surface of the thermoformed component; the surface appears essentially without structure, and therefore of particularly high quality.

Furthermore, in the aforementioned advantageous configuration, it has surprisingly proved to be advantageous in practice that, if the first and/or, if applicable, the second chamber that may also be provided, have a first or second chamber volume, and the non-compressed volume of the first or second filling is approximately 50%±15% of the first or second chamber volume. In this advantageous configuration, the first filling or the second filling is in the form of a loose infill of foam flakes.

Furthermore, in the aforementioned advantageous configuration, it has surprisingly proved to be acoustically advantageous in practice if a mixture of foam particles is used for the filling, which comprises a first component of non-viscoelastic foam and a second component of viscoelastic foam.

Surprisingly, it has been shown that an admixture of viscoelastic foam particles leads to significantly improved acoustic properties of the inventive components, compared to the generic components known from the prior art. This improvement relates on the one hand to the sound-insulating properties of the components, but on the other hand, also to the sound-absorbing properties. The sound-absorbing properties can even be better than those of a sound-absorbing body made from open-cell polyurethane foam, above a cut-off frequency that can be of the order of a few 100 hertz.

In addition, the admixture of foam flakes made from a viscoelastic foam slows down the recovery of a compressed inventive component. The admixture of viscoelastic foam flakes, for example, provides the worker with more time to bring a compressed inventive component into its installation position in a motor vehicle, which significantly simplifies the assembly component. In practice, this represents a significant advantage of an inventive component.

In this configuration, the first component preferably accounts for at least 40% and up to 60% by weight of the filling, and the second component accounts for a maximum of 60%, and at least 40%, by weight.

Here the foam of the first component has an average density of 28-40 kg/m³, and preferably of 28-30 kg/m³. The foam of the second component, on the other hand, has an average density of 40-50 kg/m³, and preferably of 40-45 kg/m³.

In the context of this preferred configuration, weight ratios of 60% of the first component to 40% of the second component, or 50% of both components, have proved to be acoustically advantageous.

It has turned out to be particularly suitable for this preferred configuration if the foam for the foam particles of the first and/or second portion comprises PUR, or consists of PUR. A polyether foam is particularly preferred for at least the foam particles of the first component. However, a polyether foam can also advantageously be used for the foam particles of the second component.

In an acoustically particularly advantageous development, the second component of the foam particles in turn comprises two fractions that differ in their density by at least 25%.

In a particularly preferred development, the first fraction of the viscoelastic component has an average density of 40 kg/m³-50 kg/m³. In contrast, the second fraction in this development has an average density of 70 kg/m³-90 kg/m³.

If the second (viscoelastic) component of the foam particles in turn comprises two fractions that differ in their density by at least 25%, it has also proved to be particularly advantageous acoustically if the proportion by weight of the first fraction is between 80% and 100%, and the proportion by weight of the second fraction is between 20% and 0%. Preferably, the proportion by weight of the first fraction is between 85% and 95%, and the proportion by weight of the second fraction is between 5% and 15%. In a very particularly preferred development, the proportion by weight of the first fraction is approximately 90%, and the proportion by weight of the second fraction is approximately 10%.

Surprisingly, it has been found that even the addition of a small proportion by weight of foam flakes made from a denser foam as proposed above, leads to a significant improvement in the acoustic insulation effect of an inventive component.

If a suitably formed, i.e. thermoformably formed, inventive component is thermoformed, an acoustically-effective moulded part is obtained, which also forms part of the subject matter of the present disclosure. This moulded part has at least sound-absorbing properties, but may also have sound-insulating properties.

Preferably, in such an inventive moulded part, the first and, if applicable, the second cover layer that may be provided, are completely joined to each other around the edges.

In an alternative configuration, in such an inventive moulded part, the first and, if applicable, the second cover layer that may be provided, are not joined to each other around the edges. For this purpose, for example, an edge that forms during thermoforming, and, if applicable, may be peripheral, can be detached by stamping in a stamping process.

Such a part can also be produced by stamping out the moulded part from a thermoformed material composite with an extended surface area, consisting of a first, and, if applicable, a second, cover layer and filling.

In an advantageous development, the inventive moulded part also has a fold line, i.e. a linear extended region of reduced material thickness. This can be introduced into the thermoformed component in the thermoforming process in which the moulded part is formed, for example.

A fold line can be used to make the moulded part adaptable to the geometry of a three-dimensionally-shaped component, on which the acoustically-effective moulded part is to be arranged. Such a component can take the form, for example, of a body part of a motor vehicle, e.g. a wheel arch, or a bonnet.

Furthermore, an inventive moulded part can have a through-hole, which can be introduced into the moulded part by stamping, for example. In a particularly preferred configuration, the through-hole has a peripheral edge of reduced material thickness.

The introduction of an edge of reduced material thickness, one or a plurality of fold lines and/or one or a plurality of through-holes, preferably with edges of reduced material thickness, are all measures that advantageously influence the three-dimensional shaping or formability of an inventive moulded part. These configurations therefore also form part of the subject matter of the present disclosure.

In a further advantageous configuration of the present disclosure, the acoustically-effective inventive moulded part has a permanent three-dimensional shape, which in particular can be adapted to the three-dimensional shape of a component on which the inventive moulded part is to be arranged. Such a three-dimensional shape can be produced, for example, by the thermoforming of a thermoformable inventive component.

When using a filling of foam particles which have a proportion by weight of at least 50% PUR, components in accordance with the disclosure are thermoformable. It is particularly advantageous if the foam particles consist of PUR. Thermoformable means that the three-dimensional shape of the inventive components can be permanently changed in a moulding tool by the action of heat. Surprisingly, it has been found that in such a case the inventive component can be thermoformed even without the addition of a thermosetting binder to the filling. Needless to say, the addition of a thermosetting binder to the filling can also be advantageous in individual cases. This also applies if the filling contains foam particles that comprise PUR.

In a further advantageous development, the inventive component or moulded part has an adhesive layer on the outer surface, with which it is intended to fix the component or moulded part to a component, for example of a motor vehicle, that is to be acoustically influenced. This adhesive layer is preferably covered with a liner before the component is mounted.

Finally, in a further advantageous development, the inventive component or moulded part is mechanically connected on the outer surface to a reinforcement part, e.g. by means of planar or punctiform bonding or welding. In the context of the present disclosure, a reinforcement part is understood to be a planar part, if applicable provided with a 3D-shaping, which has a rigidity such that it is inherently stable.

A reinforcement part for example, can, if applicable, be made from a fibre-reinforced plastic such as GRP or CFRP, or also from a metallic material, or can comprise such a material. For example, it can be an acoustically-effective cover for a thermally stressed component of the drive unit of a motor vehicle, e.g. the cylinder head or the injection system of an internal combustion engine.

In a particularly preferred development, the reinforcement part forms the second cover layer provided in accordance with the disclosure.

Thermoformed components in accordance with the disclosure can be used particularly advantageously in vehicle construction as damping elements for the drive tunnel, as bulkheads to be arranged between the engine compartment and the passenger compartment, as wheel arch absorbers, or as bonnet insulation. Such parts also form part of the subject matter of the present disclosure.

A method in accordance with the disclosure is provided for the production of an acoustically-effective component, in particular an inventive component. In its simplest manifestation, the method comprises the following steps:
a) provision of a first cover layer made from a flexible material with an extended surface area, with a specific flow resistance of between 10 and 1,500 rayls,
b) formation of a pouch from at least the first cover layer such that the pouch forms a first chamber with an access opening, and
d) filling of the chamber with a first filling, wherein the first filling has:
   i) voluminous non-woven material,
   ii) foam particles,
   iii) synthetic fibres,
   iv) natural fibres; or
   v) mixtures of the aforementioned materials.

It should be noted that, in the context of the present disclosure, the aforementioned phrase “with an extended surface area” is also to be understood to mean a tubular configuration of the first material. For example, films can be extruded directly in tubular form. Sections of such a tube can be cut to length and sealed at one end to form a pouch with a chamber. This procedure is also covered by the present disclosure.

The (first) chamber can be filled with the first filling in various ways. In a first configuration of the inventive method, the first filling is divided into portions of defined weight before being introduced into the first chamber. In other words, the filling is measured in terms of mass, and the measured filling quantity is subsequently introduced by hand or by machine into the inventive chamber provided in the pouch.

For example, extrusion of the filling has proved to be advantageous for the mechanical introduction of the filling into the chamber, especially when foam particles are used as the filling.

Alternatively, the mechanical filling of the chamber with the filling can also take place in a gravity-driven pouring process.

Surprisingly, however, it has also been found that the use of at least a first cover layer with a certain defined permeability for a gas flow allows the use of an alternative, advantageous filling method. It has been shown that the filling can be introduced into the chamber by means of an air flow as a transport medium. This procedure has proved to be particularly advantageous if at least the first cover layer has a low specific flow resistance, and/or the particles used as filling have a low density, and/or a high flow resistance.

Filling the chamber by means of extrusion, as well as by means of blowing into the chamber, or by means of a pouring process, are particularly suitable for series production of the inventive components. For example, a tubular envelope can be formed from an extended first cover layer, which is welded at one end so as to form a pouch. This pouch is then filled with a preferably loose infill of a quantity of the filling measured by weight. Finally, the second end of the pouch is closed, preferably welded, so that a closed pouch filled with a filling is obtained, which represents the inventive component.

Alternatively, a long tubular envelope can be formed from a first cover layer with an extended surface area. This envelope is then filled with the desired filling in a quasi-continuous process. Components in accordance with the disclosure can then be separated from the resulting continuous semi-finished product in a subsequent process step. The separation can take place, for example, in a stamping process.

In this procedure, the chamber is advantageously closed when the components are separated by joining the opposing cover layers, e.g. by means of welding.

An alternative procedure, which also forms part of the subject matter of the disclosure, envisages the following method steps:
a) introduction of the first cover layer into a mould, for example, a half of a thermoforming tool,
b) introduction of the first filling into the mould,
c) covering of the mould with the second cover layer,
d) joining of the first and second cover layers to form the chamber, e.g. by means of thermal welding.

In step b) the filling is preferably introduced as a loose infill.

The result of this method is a component in accordance with the disclosure.

It should be noted that the first and second cover layers can also be formed by a single contiguous flat workpiece, which is folded together to form a kind of pocket, which can subsequently be closed at the edges.

In an advantageous development of this method, it is envisaged that the first filling is compressed before the first and second cover layers are joined.

In an advantageous development of this method, it is envisaged that the composite material consisting of the first and second cover layers, together with the first filling, is thermoformed. Advantageously, the actual thermoforming step is preceded by a further method step in which the composite material is preheated, preferably in the thermoforming tool.

The result of this method is a moulded part in accordance with the disclosure.

Another contribution to the subject matter of the present disclosure is a method for the production of an acoustically-effective moulded part, in particular a moulded part in accordance with the disclosure. The inventive method has at least the following method steps.
a) provision of an acoustically-effective component in accordance with the disclosure, or the production of an acoustically-effective component in accordance with an inventive method, wherein the materials of the first cover layer and/or the first filling can be moulded thermoplastically, and
b) thermoforming of the component.

In the simplest configuration of the method, an acoustically-effective moulded part is directly formed by this means.

In an advantageous development of this method, it is envisaged that after step b) the moulded part is stamped out of the thermoformed semi-finished product.

In a development of this method, a second cover layer, and/or an intermediate layer, is also provided in the component provided.

Surprisingly, it has been found that the component used in this method can already be thermoformable if at least one layer of the first, second, and, if applicable, intermediate layers can be thermoplastically moulded.

As a result of this advantageous configuration of the inventive method, an advantageous acoustically-effective moulded part is obtained, which also forms part of the subject matter of the present disclosure. This acoustically-effective moulded part has at least the following features:
a) a first cover layer made from a flexible material with an extended surface area, which has a specific flow resistance of between 10 and 1,500 rayls,
b) a second cover layer with an extended surface area, which can be identical or at least identical in material to the first cover layer, but does not have to be,
c) an acoustic absorber layer arranged between the first and second cover layers, wherein the absorber layer has the following:
   i) voluminous non-woven material,
   ii) foam particles,
   iii) synthetic fibres,
   iv) natural fibres; or
   v) mixtures of the aforementioned materials,

In accordance with the disclosure, this moulded part is thermoformed.

Finally, an advantageous use of an inventive component or moulded part also forms part of the subject matter of the present disclosure. It has been found that both a component in accordance with the disclosure, and a moulded part in accordance with the disclosure, can advantageously find application as an acoustically-effective damping element in a motor vehicle, by virtue of their respective acoustic properties.

In particular, such a damping element can take the form of an acoustically-effective exterior or interior component.

A particularly preferred type of damping element takes the form of bonnet insulation, a capsule for an electric motor, a roof lining insulation, a side member filling, a sill filling, an A/B/C pillar filling, a bulkhead insulation, a tunnel absorber, a door insulation, or a wheel arch absorber.

Surprisingly, it has been shown that the acoustic effectiveness of a component in accordance with the disclosure increases if the component is reduced in volume by at least 30%, preferably by at least 50%, when installed in the vehicle, compared to its volume in its uncompressed quiescent state. This applies in particular if the volume of the uncompressed filling is smaller than the volume of the chamber of the pouch of the component in question. In particular this is the case if the component takes the form of a component in accordance with claim 15.

Finally, it should be noted that the filling of a second chamber, if a second chamber is envisaged in an inventive component, can advantageously make use of all advantageous configurations of the filling of the first chamber.

### BRIEF DESCRIPTION OF THE DRAWINGS

In what follows the present disclosure is explained in detail by means of examples of embodiment, with reference to the attached figures. These examples of embodiment are intended to make it easier for the person skilled in the art to execute the disclosure. They do not limit the subject matter of the disclosure. Here:

FIG. 1: shows a lateral cross-sectional view of a first example of embodiment of an inventive acoustically-effective component,

FIG. 2: shows a lateral cross-sectional view of a second example of embodiment of an inventive acoustically-effective component,

FIG. 3: shows in plan view a third example of embodiment of an inventive component,

FIG. 4: shows an inventive acoustically-effective moulded part produced on the basis of the component in FIG. 3,

FIG. 5: shows in plan view a fourth example of embodiment of an inventive component.

FIG. 6: shows a semi-finished product for an inventive acoustically-effective moulded part, produced on the basis of the component of FIG. 5, and

FIG. 7: shows another inventive moulded part obtained from the semi-finished product of FIG. 6.

### DETAILED DESCRIPTION OF THE DRAWINGS

In the figures, unless otherwise indicated, identical reference symbols denote identical or corresponding components with the same function.

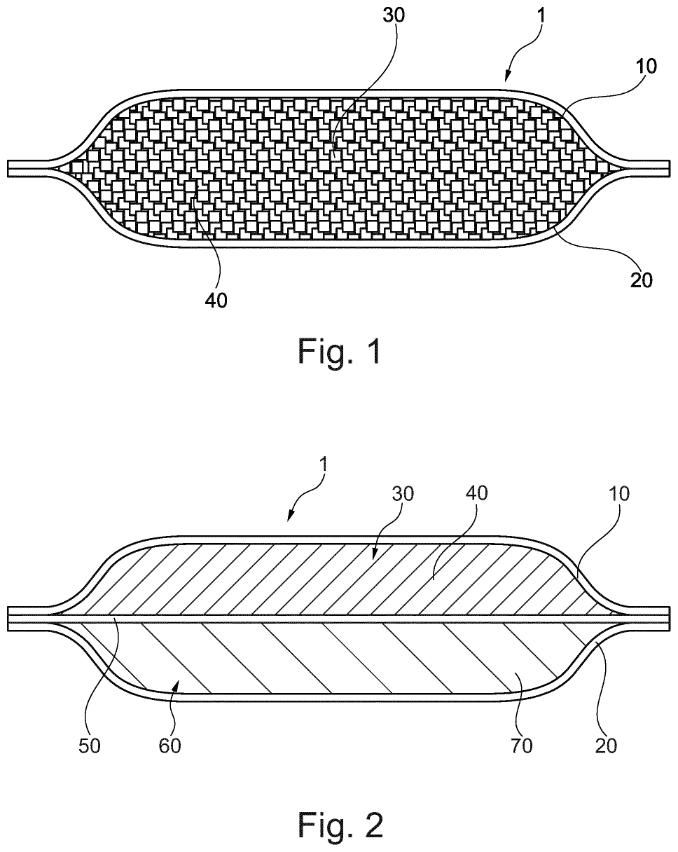

FIG. 1 shows in a lateral cross-sectional view a first example of embodiment of an acoustically-effective component 1 in accordance with the disclosure. It has a first cover layer 10 made from a non-woven material with an extended surface area, which has a specific flow resistance of 100 rayls.

A second cover layer 20 with an extended surface area is also formed by a non-woven material with an extended surface area, which has a specific flow resistance of 100 rayls.

In an alternative configuration, both non-woven materials have a specific flow resistance of 750 rayls.

Both non-woven materials are made from thermoplastic PET fibres that can be thermally welded.

The first and second cover layers 10, 20 are completely joined to each other around the edges by means of welding, so that the first and second cover layers 10, 20 together form a pouch with a chamber 30.

The chamber 30 is filled with a filling 40 consisting of foam particles made from an open-cell viscoelastic PUR foam.

In a preferred configuration of this example of embodiment, the materials used correspond to those of the advantageous configuration of an inventive component last cited in the general part of the description of this application. In particular, both the first and the second cover layers 10, 20 consist of a non-woven material with the specifications there cited.

FIG. 2 shows a second example of embodiment of an inventive acoustically-effective component in a lateral cross-sectional view.

The structure of this component essentially corresponds to that of the first example of embodiment. However, this component has an intermediate layer 50, which is arranged between the first and second cover layers 10, 20. The first and second cover layers 10, 20 and the intermediate layer 50 are joined to one another around the edges, so that the first and second cover layers 10, 20 and the intermediate layer 40 together form a pouch with two chambers 30, 60.

The first chamber 30 is filled in an analogous manner to the chamber 30 of the first example of embodiment.

The second chamber 60, on the other hand, is filled with a second filling consisting of particles of a rubber-elastic material. The typical particle size of the particles is approximately 1 mm.

The first chamber 30 forms a sound absorber, the second chamber 60, in contrast, forms a sound-insulating layer.

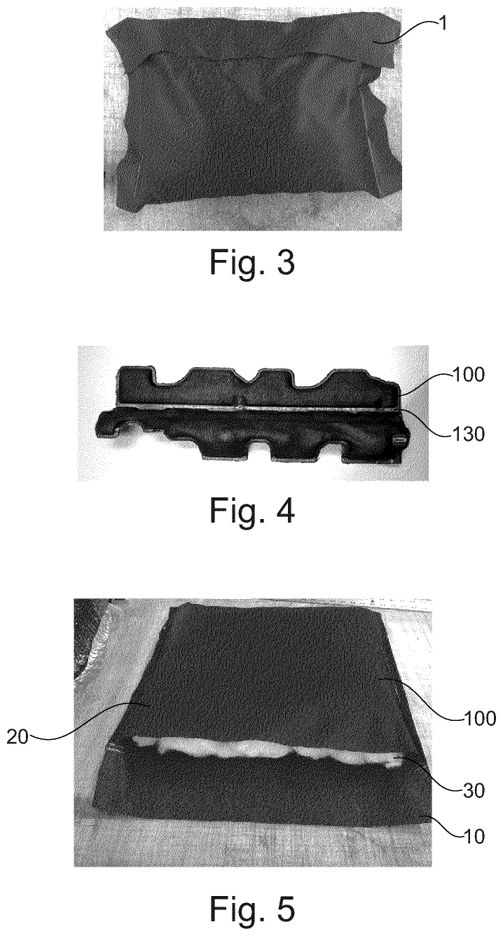

FIG. 3 shows a third example of embodiment of an inventive component 1 in plan view. This consists of a single layer of PET non-woven material, which is formed into a pouch by folding it over. The edges of the pouch are thermally welded. Again, the non-woven material can have a specific flow resistance of 100 rayls. Alternatively, the non-woven material can have a specific flow resistance of 750 rayls.

The pouch is filled with flakes of open-cell PUR foam, which are typically 7-15 mm in size. The filling weight is about 40 grams per square metre.

FIG. 4 shows an inventive acoustically-effective moulded part 100, which is produced on the basis of the component 1 in FIG. 3 in a thermoforming process, and which is a cover for the common rail injection system of an internal combustion engine. The moulded part 100 has a fold line 130, which gives the moulded part 100 a 3D-deformability.

FIG. 5 shows a plan view of a fourth configuration of a component 1 in accordance with the disclosure. This consists of a single layer of PET non-woven material, which is formed into a pouch by folding it over. The edges of the pouch are thermally welded. The non-woven material again has a specific flow resistance of 100 rayls. The pouch has dimensions of approximately 50 cm×60 cm.

The pouch is filled with flakes of recycled PET fibres, which contain about 50% by weight of bicofibres. The bicofibres have a low-melting envelope of PET. The melting point of the envelope is about 110° C. The filling weight is about 1,000 grams per square metre.

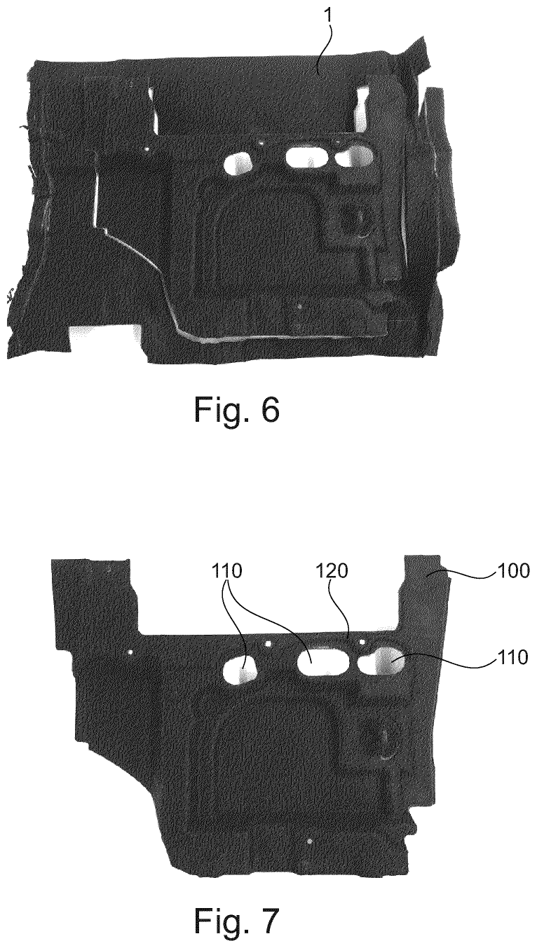

FIG. 6 shows a semi-finished product for an inventive acoustically-effective moulded part 100, produced on the basis of the component 1 of FIG. 5 in a thermoforming process.

Finally, FIG. 7 shows a moulded part 100 in accordance with the disclosure obtained by stamping from the semi-finished product of FIG. 6; this takes the form of a bulkhead for separating compartment from the engine compartment of a motor vehicle with an internal combustion engine.

It is evident that the moulded part 100 has several through-holes 110, all of which have a circumferential edge 120 of reduced material thickness.

As can clearly be seen in FIG. 6, the first and second cover layers 10, 20 are no longer joined to each other at the edges in the semi-finished product, and therefore they are not joined in the finished moulded part 100.

In another example of embodiment, a needled non-woven material is provided as the first cover layer. The non-woven material consists of PET fibres, which are thermoplastic. Here the thickness of the non-woven material is approx. 1.10 millimetres, and its weight per unit surface area is 40 g/m³. The air permeability of the non-woven material in accordance with DIN EN ISO 9237 is 5,500 litres/m²s.

The cover layer is formed into a tube in sections, wherein the longitudinal seam is formed by thermal welding of the non-woven material.

One end of the tube is also closed by means of thermal welding to form a pouch.

Remnants of an open-cell, non-viscoelastic polyether foam are mechanically shredded so that flakes with an average size of about 15 millimetres are obtained. The polyether foam has a density of between 28 kg/m³ and 40 kg/m³.

Furthermore, remnants of two open-cell, viscoelastic polyether foams are mechanically shredded so that flakes with an average size of about 15 millimetres are obtained. The first viscoelastic polyether foam has a density of between 40 kg/m³ and 50 kg/m³. The second viscoelastic polyether foam has a density of approximately 80 kg/m³.

The foam flakes resulting from both viscoelastic foams are mixed in a machine mixer, in a weight ratio of 90% of the foam with the lower density, and 10% of the foam with the higher density.

The resulting viscoelastic foam mixture is mixed in a machine mixer with the foam flakes from the non-viscoelastic foam, in a weight ratio of 40% viscoelastic content to 60% non-viscoelastic content.

Individual portions are taken from the resulting foam flake mixture, the size of which is determined based on the weight of the portions. The weight of a portion is calculated in such a way that the density of the filling in the volume of the ready-to-use pouch is in the region of 24 kg/m³.

The individual portions are gravity-fed via a hopper as loose infill into a wide non-woven material pouch. For this purpose, the non-woven material pouch is pulled over the spout of the hopper.

Finally, the filled pouch is fed to a welding machine, which closes the pouch at its end that is still open by means of thermal welding.

The typical dimensions of the pouches produced in this way are about 10 cm to 150 cm in length and about 5 cm to 50 cm in width.

If pouches obtained in this manner are compressed by 50% in terms of volume compared to their force-free/relaxed configuration, their acoustic damping capability is higher than that of a pure polyether foam from a cut-off frequency in the region of a few hundred Hertz.

In a final example of embodiment, a duplo-film with an extended surface a area is provided; this comprises thermoplastic layer of PE, so that the plastic film can be thermally welded, for example.

The thickness of the plastic film is about 40 microns and its density is about 1.0 g/cm³.

Furthermore, the plastic film is designed to be flame-retardant in accordance with prior art.

The plastic film has a micro-perforated design, wherein the characteristic dimensions of the micro-perforations are about 60 microns. The density of the micro-perforations is selected so that the plastic film has a specific flow resistance of 100 rayls±20 rayls.

The plastic film is formed into a tube in sections, wherein the longitudinal seam is formed by thermal welding of the plastic film.

One end of the tube is also closed by thermal welding to form a pouch.

Remnants of an open-cell, non-viscoelastic polyether foam are mechanically shredded so that flakes with an average size of about 15 millimetres are obtained. The polyether foam has a density of between 28 kg/m³ and 40 kg/m³.

Furthermore, remnants of two open-cell, viscoelastic polyether foams are mechanically shredded so that flakes with an average size of about 15 millimetres are obtained. The first viscoelastic polyether foam has a density of between 40 kg/m³ and 50 kg/m³. The second viscoelastic polyether foam has a density of approximately 80 kg/m³.

The foam flakes obtained from the two viscoelastic foams are mixed in a machine mixer in a weight ratio of 90% of the foam with the lower density and 10% of the foam with the higher density.

The resulting viscoelastic foam mixture is mixed in a machine mixer with the foam flakes from the non-viscoelastic foam in a weight ratio of 40% viscoelastic content to 60% non-viscoelastic content.

Individual portions are taken from the resulting foam flake mixture, the size of which is determined based on the weight of the portions. The weight of a portion is calculated in such a way that the density of the filling in the volume of the ready-to-use pouch is in the region of 24 kg/m³.

The individual portions are gravity-fed via a hopper as a loose infill into a wide film pouch. For this purpose, the film pouch is pulled over the spout of the hopper.

Finally, the filled pouch is fed to a welding unit, which closes the pouch at its end that is still open by means of thermal welding.

Such a component has a particularly high acoustic absorption capability in the medium to higher frequency range of the human hearing spectrum.

1) An acoustically-effective component, comprising:
a) a pouch formed from at least a first cover layer, which forms a first chamber, wherein the first cover layer comprises a flexible material with an extended surface area and a specific flow resistance of between 10 and 1,500 rayls,
b) a first filling, which is arranged in the first chamber, wherein the first filling comprises:
i) voluminous non-woven material,
ii) foam particles,
iii) synthetic fibres,
iv) natural fibres; or
v) mixtures of the materials.

2) The acoustically-effective component in accordance with claim 1, wherein the component has a second cover layer with an extended surface area, wherein the first and second cover layers are joined together at the edges, so that the first and second cover layers together form the pouch with the first chamber.

3) The component in accordance with claim 1, wherein the material of the first cover layer and/or the material of the second cover layer can be welded.

4) The component in accordance with claim 1, wherein the material of the first cover layer and/or the material of the second cover layer is a non-woven material, or comprises such a material.

5) The component in accordance with claim 4, wherein the non-woven material of the first cover layer and/or the non-woven material of the second cover layer has one or a plurality of the following features:
a) a thermoplastic fibre material, or is formed from such a material,
b) takes the form of a needled non-woven material,
c) the thickness of the non-woven material is between 0.7 and 1.5 millimetres,
d) the weight per unit surface area of the non-woven material is between 30 and 50 g/m³, and
e) the air permeability of the non-woven material in accordance with DIN EN ISO 9237 is 4,000-6,000 l/m²s.

6) The component in accordance with claim 1, wherein the first cover layer is sewn, pressed, bonded or welded to itself, or to the second cover layer, so as to form the pouch.

7) The component in accordance with claim 1, wherein the pouch forms at least a first and a second chamber, wherein the second chamber is filled with a second filling, wherein the second filling comprises:
a) voluminous non-woven material,
b) foam particles,
c) synthetic fibres,
d) natural fibres, or
e) mixtures of the materials.

8) The component in accordance with claim 7, wherein the first and second fillings are identical or different.

9) The component in accordance with claim 7, wherein the component has an intermediate layer that separates the first and second chambers from one another.

10) The component in accordance with claim 1, wherein the material of the first cover layer, and/or the material of the second cover layer, and/or the material of the intermediate layer is a film, or comprises such a film.

11) The component in accordance with claim 10, wherein the film has one or a plurality of the following features:
a) the film is media-impermeable or micro-perforated, wherein the characteristic dimensions of the micro-perforations are smaller than 100 microns,
b) the film comprises a thermoplastic material, or is formed from such a material,
c) the thickness of the film is between 30 and 100 microns,
d) the density of the film is between 0.8 and 1.2 g/cm³,
e) the film comprises at least two layers, and
f) the film can be welded, for example thermally, by ultrasound or by friction welding.

12) The component in accordance with claim 1, wherein the foam particles comprise an open-cell, and/or a mixed-cell, foam.

13) The component in accordance with claim 1, wherein the foam particles have an average size of at least 10 millimetres.

14) The component in accordance with claim 12, wherein the first and, if applicable, the second filling, have an average density of 24 kg/m³±6 kg/m³.

15) The component in accordance with claim 12, wherein the first and, if applicable, the second chamber, have a first and a second chamber volume, and the non-compressed volume of the first and second fillings is approximately 50%±15% of the first and second chamber volume respectively.

16.-23) (canceled)

24) The component in accordance with claim 9, wherein the first and second fillings have different densities, and/or comprise different materials and/or material compositions.

25) A method for the production of an acoustically-effective component, the method including the following steps:
a) providing at least one first cover layer made from a flexible material with an extended surface area, and a specific flow resistance of between 10 and 1,500 rayls,
b) forming a pouch from at least the first cover layer, such that the pouch forms a first chamber with an access opening,
c) filling the first chamber with a first filling, wherein the first filling comprises:
i) voluminous non-woven material,
ii) foam particles,
iii) synthetic fibres,
iv) natural fibres,
v) particles of a polymeric or rubber-elastic heavy-duty layer, or
vi) mixtures of the above materials; and
d) closing the access opening to the first chamber.

26.-27) (canceled)

28) An acoustically-effective moulded part, comprising a thermoformed component in accordance with claim 1.

29) A method for the production of an acoustically-effective moulded part, the method including the following steps:
a) provision of an acoustically-effective component comprising:
a pouch formed from at least a first cover layer, which forms a first chamber, wherein the first cover layer comprises a flexible material with an extended surface area and a specific flow resistance of between 10 and 1,500 rayls; and
a first filling, which is arranged in the first chamber, wherein the first filling comprises: voluminous non-woven material, foam particles, synthetic fibres, natural fibres or mixtures of the materials, or the production of an acoustically-effective component in accordance with a method in accordance with claim 25, wherein the materials of the first cover layer and/or first filling can be thermoplastically moulded, and
b) thermoforming of the component.

30) The method in accordance with claim 29, wherein after step b), the moulded part is stamped out of the thermoformed component.

31) Use of an acoustically-effective component comprising a pouch formed from at least a first cover layer, which forms a first chamber, wherein the first cover layer comprises a flexible material with an extended surface area and a specific flow resistance of between 10 and 1,500 rayls; and a first filling, which is arranged in the first chamber, wherein the first filling comprises: voluminous non-woven material, foam particles, synthetic fibres, natural fibres or mixtures of the materials, or a moulded part in accordance with claim 28, as an acoustically-effective damping element in a motor vehicle.

32) (canceled)

33) The use in accordance with claim 31, wherein the damping element takes the form of an acoustically-effective interior or exterior component.

34) The use in accordance with claim 31, wherein the damping element takes the form of a side member infill, a sill infill, an A/B/C pillar infill, a bulkhead insulation, a tunnel absorber, a door insulation, or a wheel arch absorber.
